(19) United States
(12) Patent Application Publication
(10) Pub. No.: US 2004/0065358 A1
(43) Pub. Date: Apr. 8, 2004

(54) Treatment device for wafers

(76) Inventors: Thorsten Teutsch, Berlin (DE); Elke Zakel, Falkensee (DE)

Correspondence Address: Greenblum & Bernstein, 1941 Ronald Clarke Place, Reston, VA, 20191, US

(21) Appl. No.: 10/399,547

(22) PCT Filed: Oct. 24, 2001
(86) PCT No.: PCT/DE01/04036

(30) Foreign Application Priority Data
Oct. 24, 2000 (DE) 10052724.8

(51) Int. Cl. B08B 3/00

(52) U.S. Cl. 134/198; 134/902

(57) ABSTRACT

A treatment device for cleaning or ashing surfaces of flat wafers (10), wherein at least one flat base plate (30) is provided as an electrode in a treatment chamber (40), said treatment chamber being adapted to be evacuated. Depressions (31) are formed and distributed in said base plate such that they are suitable for receiving support pieces (20), said depressions having at least one arrangement or positioning adapted to a shape of a wafer to be treated. Each support piece has at least one support surface a height of which, after inserting a support piece into a respective depression, comes to rest at a level (a) above the base plate.

The invention relates to a treatment device in accordance with one of independent claims 1 to 4. The invention substantially relates to modifying wafers with respect to their property or condition, i.e. with respect to their surface. The surface shall be processed or treated, both, a cleaning and another—also partial—treatment of a surface being comprised by the invention.

According to prior art, treatment devices are proposed for such wafers, in which devices wafers are put on metallic plates and then treated with a plasma or with a reactive ion etching method (RIE). By said methods, the wafers are damaged too frequently, particularly by mechanically contacting said metallic base plates, whereby the occurrence of varnish scratches and other mechanical scratches on the sensitive surface cannot be excluded.

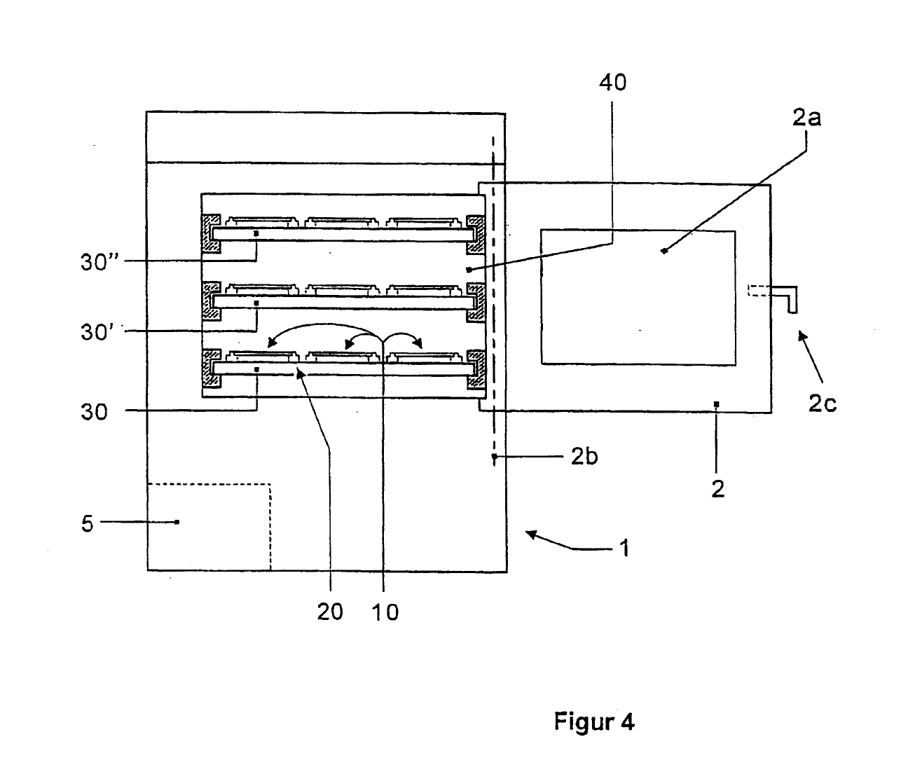

From U.S. Pat. No. 5,044,871 (Davies), a carrier arrangement for wafers is accessible to the expert, FIG. 3 of said document referring to support pieces 50, and the corresponding description, column 10, line 55 to column 11, line 16 describing “pins” (50) which are designed to have a column shape and which are movable for transporting the wafers. Also a more detailed description of said column-shaped pins cannot be taken from the document U.S. Pat. No. 4,659,413 (Davies) referenced there, at best, support pieces (155) being provided according to FIG. 13 which are not positioned in depressions. They are described as “centering pins”, cf. column 11, lines 8 to 54, particularly lines 35 to 42. Finally, JP-A 57-70278 (Nec) describes an apparatus for supporting wafers, said apparatus also comprising column-shaped pins (4) which are movable in upward and downward direction over a spring arrangement through a bottom hole, compare Abstract (Patent Abstracts of Japan).

Therefore, an object of the invention is to treat wafers with more care and to modify by radiation only those surface portions of a wafer with plasma or another processing method in a device, which surface portions are effectively intended to be modified, particularly to exclude undesired scratch damages on a light-treated (exposed) surface directing downwards (towards an electrode).

Said object is solved in accordance with one of claims 1 to 4 or 13 or 20.

The invention starts out from the fact that wafers shall not be placed onto metallic plates as counter-electrodes, but that they are supported at a distance therefrom (claim 1, claim 23). Said support is provided by (resting or stationary) support pieces which are lodged in depressions or troughs, thus forming several distributed bases onto the edges of which said wafers can be placed. On a base plate having a surface, a distance of the contact surface from the surface of the base plate is dimensioned such that said distance is considerably below a free path length of the plasma, in a range of between fore-pressure and high-vacuum. According to the invention, pressures of between 10⁻¹ to 10⁻² mbar are talked about.

The support pieces are self-insulating and resistant to vacuum (claim 20). They are resistant to plasma, usually they are made of a ceramic material or Teflon. They have a height extension and a lateral extension (claim 24 and 26, 27). The height can functionally be described such that an independently standing support piece which is inserted in a depression, does not tilt or fall (claim 25). A depression provides support by having an at least partly plane bottom (claim 23), said bottom supporting a corresponding flat bottom surface of a body of said support piece. Thus, inserted support pieces are stationary or resting without being moved laterally or vertically for their function. Due to their stationary positioning with respect to the counter-electrode, said support pieces with their relatively broad and flat support surface provide a scratchproof support and bearing of the wafers at an edge portion and also at a sensitive surface side thereof. A free path length or distance between a downward directing surface of a wafer and a counter-electrode can be adjusted to be as small as possible, when the support pieces come to rest stationarily and restingly, thus being stable at defined positions.

A further object of the invention is flexibility. Flexibility is obtained by arranging several depressions in the surface for receiving equally configured support pieces as sockets or bases. One group of depressions, respectively, is attributed to each other and serves for receiving one wafer size. When treating a larger or a smaller wafer size, another group of depressions can be provided with support pieces, for supporting said new size of wafers in a vertical direction, keeping said wafers at a distance with respect to the surface of the base plate which serves as counter-electrode.

The individual groups are adapted to the size of the wafers to be treated. When round wafers are provided, said groups can be arranged in the manner of radius vectors, wherein on each radius vector extending in a radially different direction, one depression of a group of depressions can be used for positioning a support piece therein. One depression of each group of provided radius vectors, mostly three, is a component of a geometrical support arrangement for supporting a wafer of a given size (claim 4).

At the centre, an additional depression can be provided, for receiving a support piece of a smaller height extension, said additional support piece for security purposes only having a height, said height being between the bottom side of a wafer and the top side of the base plate. (claim 15). Thereby, sagging of a wafer can be avoided, also in case of a stronger load or a larger distance of the remaining support pieces supporting the wafers at their outer edges.

The depressions are adapted to receive said support pieces (claim 14). In most cases, the depressions are recommended to have a round shape of, so that round support pieces can be inserted in said depressions (claim 10, claim 11). However, a round shape is not imperative, rectangular support pieces can be used as well, the depressions then being adapted in shape.

Above a base plate (as an electrode), a treatment chamber is provided in which the plasma is active. A radiation provided in said chamber vertically hits the wafers distributed across a surface and treats a surface which is exposed to the plasma. A surface treatment is effected, but only a punctual support of the wafers at the support pieces (as sockets) takes place. Due to the provided plasma, said treatment chamber is adapted to be evacuated, known vacuum-producing arrangements being used for said evacuation in connection with the treatment device according to the invention.

The depressions are adapted to fit to the support pieces, for only partly receiving them. Further, the depressions are positioned to be adapted to at least one shape of the wafer to be treated. This concerns several depressions, particularly three, which as a group are adapted to receive several support pieces for forming particularly three contact points (in the sense of small contact surface portions) for the bottom side of a wafer, at an edge portion of said support pieces. Several supporting arrangements corresponding to said arrangement principle (claim 13) can be provided on one base plate. When said base plate is occupied by support pieces in geometrically corresponding depressions provided for said support pieces, wafers of a given size can be placed thereon and the base plate can be pushed in (claim 19).

Several such plates can be arranged one upon the other (claim 18), each individual base plate being removable from an opened treatment chamber to have access to the wafers placed on said plates. When all base plates arranged one upon the other are pushed in and the treatment chamber is closed by a door, a vacuum can be established, and treatment of all wafers distributed one above the other and laterally in said treatment chamber can be started.

Each of the described support pieces (claim 20) comprises a head and a body. Said head is adapted to limit a lateral displacement of the wafers, whereas said body portion comprising a contact surface facing in upward direction is suitable for maintaining a wafer in a fixed vertical position by contacting a portion of said wafer. However, said head portion protrudes beyond said surface for vertically supporting wafers. On the bottom side, said support pieces are provided with a flat surface, said flat bottom surface interacting with a receiving bottom of a respective depression or cavity in the counter-electrode for providing support. In a vertical direction, said support pieces are stationarily supported by a bottom-to-bottom contact. In a lateral direction, a tilting is substantially impossible due to the height/width relation (claim 25).

A distance relation of the heads of a group of inserted support pieces is adapted such that a wafer can be placed between them, said wafer being at least substantially fixed to have a small clearance in a lateral direction by said at least three head portions of said at least three support pieces. Minor displacements are permitted as long as the admissible clearance does not leave the lateral extension of the provided contact surfaces of the body portions of said support pieces. Thus, an excessive lateral displacement is avoided, said excessive displacement being described such that an edge portion of a wafer which is attributed to a support piece is displaced beyond a distance of an associated contact surface.

In the following, the invention is described in more detail on the basis of the figures.

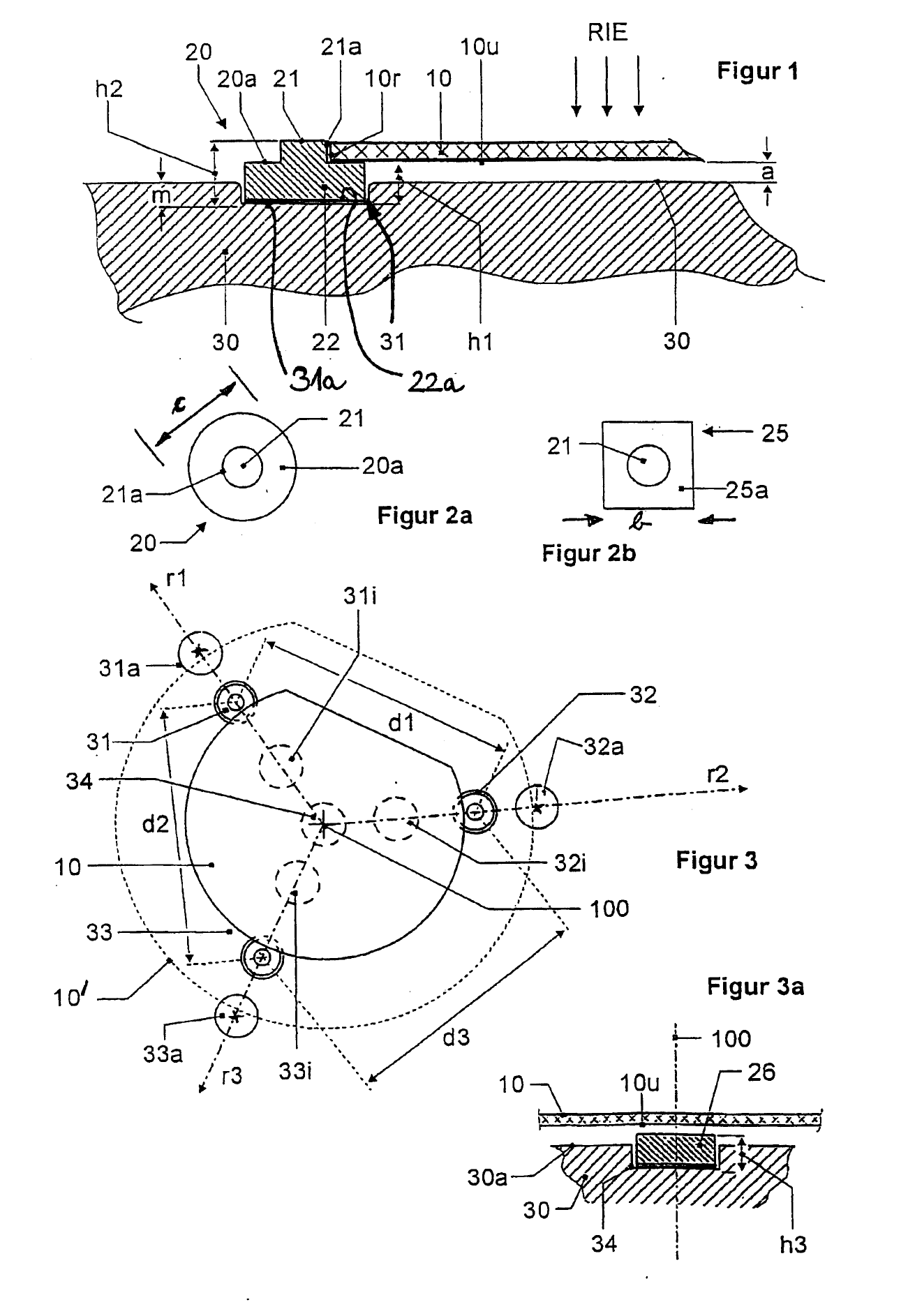

FIG. 1 is a detail illustrating a cross-section through a plane of a support plate 30 in which a support piece 20 is provided which carries a wafer 10 at an edge portion.

FIG. 2a

FIG. 2b illustrate two different forms of support pieces 20,25 in a top plan view.

FIG. 3 illustrates in a top plan view a geometrical arrangement of several groups of receiving depressions which are not occupied by support pieces 20,25, two wafer sizes 10,10′, however, being schematically indicated for illustrating a spatial geometrical arrangement of said depressions. Said wafer sizes would be placed on said support pieces shown in FIGS. 1, 2a,2b, when, in advance thereto, said support pieces would have been stationarily inserted in geometrically adapted depressions.

FIG. 3a is a detail of a centre 100 according to FIG. 3, illustrated as a detail and in a cross-sectional view.

FIG. 4 is a front view of an opened treatment device 1 with a view of and into a treatment chamber 40.

FIG. 1 illustrates a cross-section through a plate-shaped electrode 30 in which a receiving depression 31, comprising a substantially flat bottom portion 31a, is provided. In said receiving depression, a support piece 20 is arranged, which in cross-section is designed to comprise a body 22 and a head 21 which is smaller with respect to said body. A surface of said body 22 is adapted as a contact surface 20a on which an edge portion of a marked wafer 10 rests. By resting on said contact surface 20a, said wafer 10 with its bottom side 10u has a distance “a” from a surface 30a of said electrode 30. A reactive ion etching (RIE) treatment by radiation in a treatment chamber 40 is schematically illustrated, the radiation acting from above, onto the surface of the wafer.

The wafer comprises a lateral edge 10r having a small distance from a periphery 21a of said head 21. The lateral extension¹ ¹ Remark of the translator: In the original German text, the sentence is incomplete.

The height geometries and the height relations shall be explained in the following, after having referred to the top plan views of FIGS. 2a and 2b. Said figures show two top plan views of two embodiments of support pieces 20, FIG. 2a illustrating a circular support piece having a (cylindrical) round body 22 and a (cylindrical) round head 21. A surface 20a is the difference of the total surface of said body 22 and the head portion 21 located therein which thus leaves an effective remaining surface portion 20a. In a tetragonal or polygonal embodiment, particularly as a polygon, a top plan view according to FIG. 2b and a support piece 25 comprising a correspondingly formed surface 25a is obtained, a (cylindrical) head 21 also having circular shape. The lateral extension of said support piece 20 corresponds to a diameter c with respect to the body. In FIG. 2b, the lateral extension is polygonal, in this embodiment, the lateral dimension b is also referred to the body 25a of the support piece 25 illustrated here. Each support piece has a bottom side which for support piece 20 is visible in the body portion 22 at 22a according to FIG. 1. Said bottom surface interacts or cooperates with the bottom surface 31a of the receiving depression 31, so that a surface support is provided at least in part, without a vertical movement being effected by said support pieces.

The height relation according to FIG. 1 shows that said head 21 together with said body 22 has a total height h2. The receiving depression 31 has a depth m, and the height of the body 22 is h1. If said height h1 is larger than said depth m, a difference a results, said difference a corresponding to the distance of the bottom side 10u of said wafer 10 when resting on said surface 20a. The height h2-h1 results in the height of the head 21. It can be adapted to the wafer thickness of said wafer 10, but it can also be markedly higher and slightly below said wafer thickness, but it should at least have such a height that the wafer has only a small clearance between several spaced heads 21, said wafer thus coming to rest safely fixed between several spaced support pieces which will be explained on the basis of the remaining figures.

FIG. 3 illustrates the geometry of the depressions which are illustrated in groups on radius vectors. A first radius vector r1 and a second radius vector r2 and a third radius vector r3 direct in three directions offset at an angle of 1200, three depressions being disposed on each radius vector at a given distance such that a geometry is formed by a combination of one depression respectively of each of the three radius Vectors, said geometry being suitable for supporting a wafer 10. An alternative (larger) wafer 10′ is illustrated, using other depressions for being supported. A group of depressions is arranged along each radius vector. The radius vector r1 comprises depressions 31, a depression 31a located further outward and a depression 31i located further inward. The same applies for a depression 32 on said radius vector r2, a depression 32i located further inward and a depression 32a located further outward. The same also applies for a depression 33, a depression 33a located further outward and a depression 33i located further inward. In the embodiment, a wafer 10 is illustrated to partly cover said depressions 31, 32 and 33. When support elements according to FIG. 2 are inserted in the three last mentioned depressions, a head 21 with its periphery 21a substantially contacts an edge 10r of said wafer 10, only a small distance being provided which should not be larger than a portion of the contact surface, which portion is radially inside of said periphery 21a. The centres of the depressions are thus slightly offset in an outward direction with respect to the periphery of the wafer to obtain a geometrical extension of said head 21.

When a larger wafer 10′ is provided, said further outward depressions 31a, 32a and 33a are used, also by inserting equal support pieces 20 as in FIG. 2a, the support pieces mentioned before having been removed.

At a centre 100 (indicates a vertical symmetry axis), an additional depression 34 is provided which is explained in more detail in FIG. 3a. According to said figure, said depression receives a support piece 26 of a smaller height which still has a distance from a bottom side 10u of a wafer 10 to come into a contacting engagement only when a wafer deflects, is overloaded or, due to larger distances of the support depressions 31a, 32a and 33a, has a tendency to deflect. A height h3 is shown which is smaller than said distance “a” according to FIG. 1. A detail of a surface 30a of an electrode 30 and of a wafer 10 is also illustrated.

The spatial geometry of FIG. 3 provides support arrangements, each comprising three support pieces being spaced apart from each other and inserted in depressions. Said support pieces which, in the illustrated embodiment, are inserted in depressions 31, 32 and 33, provide a support arrangement, also called carrying arrangement, said arrangement providing both, an axial support and a stop of an excessive lateral displacement, oriented at an extension of said heads 21 with their periphery 21a. The geometry is defined by distances d1, d2, d3, which geometry being oriented at the centres of the depressions, corresponding to the centres of the heads. It has already been mentioned that the depressions are slightly displaced in an outward direction with respect to the edge dimension of the wafer, a larger portion of the depressions therefore being outside of the wafer rather than below the wafer for support purposes, due to the extension of said head 21 with its periphery 21a. Consequently, the dimensions are oriented such that the wafer fits between said head portions 21 of said three inserted support pieces. When a larger wafer is selected, other spaced depressions are used to form the support arrangement.

One support element, respectively, of each group of support pieces arranged on a radius vector is used for composing a geometry, for support purposes.

A treatment chamber 40 according to FIG. 1 is schematically illustrated in FIG. 4 by means of a device. Said device comprises a vacuum arrangement 5 and a treatment chamber 40 which can be closed with a door 2. Said door can be provided with an inspection glass 2a and is vacuum-tight in a closed state, so that said treatment chamber can be evacuated and a RIE radiation can be released from above. The individual levels 30, 30′ and 30″ correspond to the level 30 illustrated in FIG. 1. Several wafers are distributed across one base plate 30 and can be pushed out at skid rails which are arranged laterally in said treatment chamber 40.

When a treatment is finished, said door 2 is opened at a hinge 2b and the wafers are successively removed from the support pieces after pulling out the electrode drawer.

Several possibilities of treatments in said chamber 40 can be envisaged. Lacquer layers on a wafer can be removed. They can be ashed. Said treatment can occur on both, the front side and the rear side. When selective metallic contact places are provided on a wafer, said metallic places can also be cleaned.

Lacquers which are applied as an intermediate step for a process, to run or to selectively run chemical processes, can again be removed in said arrangement. Due to the provided support pieces 20 which are schematically illustrated in FIG. 4, the wafers 10 do not contact said base plate 30, 30′ and 30″. They have a distance a, as illustrated in FIG. 1, FIG. 1 illustrating only one support piece at a depression 31, and the remaining support pieces are designed to correspond to FIG. 3, as illustrated in FIG. 4. The additional central support pieces 26 in the central depression 34 are not illustrated in FIG. 4.

Said support pieces can be made of Teflon or a ceramic material. They should be plasma-resistant and vacuum-resistant.

Another description of FIG. 3 with the three illustrated radius vectors resides in an indication of concentric circles on which the depressions are arranged, one depression, respectively, of one group of depressions (along a radius vector) geometrically corresponding to a respective other depression on each of the two other radius vectors to be adapted to a wafer 10. On said concentric circles, the depressions can also be adapted not to be arranged along a radius vector, but offset against each other, when they are at least geometrically adapted to a wafer observing its geometry, so that a support function is provided at an edge portion of said wafer.

1. A treatment device for cleaning or ashing surfaces of flat wafers (10),
(a) at least one flat base plate (30) being provided as an electrode in a treatment chamber (40), said treatment chamber being adapted to be evacuated;
(b) said base plate (30) having formed and distributed depressions (31,32,33) suitable for receiving support pieces (20,25), said depressions having at least one arrangement (positioning) adapted to a shape of a wafer (10) to be treated;
wherein each of said support pieces (21,25) having at least one support surface (20a,25a), a height (h1) of which, after inserting a support piece into a respective depression, coming to rest at a level (a) above said base plate (30), at least in a surface portion (30a) of said base plate (30) which surface portion being below a wafer (10) when resting upon said support pieces.

2. A treatment device for cleaning or ashing surfaces of flat wafers (10),
(a) at least one flat base plate (30) being provided as an electrode in a treatment chamber (40), said treatment chamber being adapted to be evacuated;
(b) said base plate (30) having formed and distributed depressions (31,32,33) suitable for receiving support pieces (20,25), said depressions having at least one arrangement (positioning) adapted to a shape of a wafer (10) to be treated;
wherein the distribution of said depressions (31,32,33) is adapted to the shape of at least one of said wafers (10), and several, particularly at least three depressions (31,32,33) are arranged at a distance (d1,d2,d3) from each other, said distance allowing said wafer (10) to rest on several support pieces (20) inserted into said several depressions.

3. A treatment device for cleaning or ashing surfaces of flat wafers (10),
(a) at least one flat base plate (30) being provided as an electrode in a treatment chamber (40), said treatment chamber being adapted to be evacuated;
(b) said base plate (30) having formed and distributed first depressions (31,32,33) suitable for receiving support pieces (20,25), said first depressions having at least one arrangement (positioning) adapted to a shape of a wafer (10) to be treated;
wherein further depressions (31a,31i; 32a,32i) are provided in several directions (r1,r2,r3) starting from a centre (34,100), distances of said further depressions from said centre being at least one of larger and smaller than distances said first depressions (31;32) have from said centre.

4. A treatment device for cleaning or ashing surfaces of flat wafers (10),
(a) at least one flat base plate (30) being provided as an electrode in a treatment chamber (40), said treatment chamber being adapted to be evacuated;
(b) said base plate (30) having formed and distributed depressions (31,32,33) suitable for receiving support pieces (20,25), said depressions having at least one arrangement (positioning) adapted to a shape of a wafer (10) to be treated;
wherein several groups of depressions are provided (31a,31,31i; 32a,32,32i), said groups of depressions being suitable for receiving equally configured support pieces (20;25) and
(aa) one depression (31) respectively of a first group geometrically corresponds to one depression (32) of a second group, for receiving a wafer (10) to rest thereupon, said wafer having a defined first wafer size;
(bb) a further depression (31a) of said first group corresponds to a further depression (32a) of said second group, for receiving a second wafer (10′) to rest thereupon, a size of said second wafer differing from said first wafer size.

5. The treatment device of one of the aforementioned claims, wherein said support pieces (20;21,22) are made of an insulating material.

6. The treatment device of claim 5, wherein said support pieces (20) as resting or stationary pieces are at least one of vacuum-resistant and plasma-resistant.

7. The treatment device of one of the aforementioned claims, wherein said support pieces (20) have a body (22) and a head (21), said head (21) having a smaller lateral extension than said body (22).

8. The treatment device of claim 7, wherein a surface portion of a surface (20a) of said body which is not occupied by said head, serves in part as a support surface for a wafer (10).

9. The treatment device of claim 7, wherein said head (21) has a height extension (h2-h1), said height being substantially adapted to a thickness of the wafer.

10. The treatment device of one of the aforementioned claims, wherein said support piece (20) has a round shape in at least a body portion (22) thereof.

11. The treatment device of one of the aforementioned claims, wherein said support piece has a head portion (21) of round shape.

12. The treatment device of one of the aforementioned claims, wherein the support surfaces (20a) of said support pieces (20) are configured to laterally support a respective wafer (10) against slipping said support surface (20a) being suited for vertically supporting a wafer above the electrode (30).

13. A treatment device for cleaning or ashing surfaces of flat wafers (10),
(a) at least one flat base plate (30) being provided in a treatment chamber (40), said treatment chamber being adapted to be evacuated;
(b) said base plate (30) having formed and distributed depressions (31,32,33) suitable for receiving support pieces (20,25), said support pieces being elevated in an inserted state, and for forming at least one adapted (stationary) support arrangement, adapted to a shape of a wafer (10) to be treated.

14. The treatment device of one of the aforementioned claims, wherein said support pieces, particularly body portions (22) thereof, are adapted in a lateral direction to a lateral depression extension (31,32,33), for being in part received by said depression (31,31a) to rest therein.

15. The treatment device of one of the claims, wherein an additional depression (34) is provided between several depressions (31,32,33), for receiving a further insulating body (26), a height extension (h3) of which being between a bottom side of a wafer (10u) and a top side (30a) of said base plate.

16. The treatment device of one of claims 2, 3 and 4, wherein said depressions are distributed like concentric circles, several depressions, particularly at least three depressions, being provided on each of said concentric circles for receiving support pieces (20), a wafer size (10,10′) being attributed to each of said concentric circles.

17. The treatment device of claim 4, wherein a group of depressions being positioned along a radius vector (r1,r2), particularly at regular distances or adapted to standard diameters of different wafer sizes.

18. The treatment device of one of the aforementioned claims, wherein several base plates (30) are arranged one upon the other in an apparatus (1), or in a plasma device comprising said treatment chamber (40) and in said treatment chamber, particularly for being drawn individually and independently out of said treatment chamber.

19. The treatment device of claim 18, wherein several wafers are supported on support pieces (20) on each base plate, at a height distance (a) from said base plate (30,30a).

20. Support piece for use with a treatment device according to one of the aforementioned claims, said support piece being made of an insulating material and comprising a body portion (21) and a head portion (22) protruding with respect to said body portion, wherein
(i) said body portion comprises a laterally extending support surface (20a), for vertically supporting one of the flat sides of a wafer (10);
(ii) said head portion (21) next to said support surface is adapted to form a stop against an (excessive) lateral displacement of the resting wafer (10) when an edge (10r) of said wafer (10) contacts said stop.

21. The support piece of claim 20, wherein said head being substantially smaller than said body, particularly in a lateral direction.

22. The treatment device of one of the aforementioned claims or the support piece of claim 20, for use in one of cleaning a wafer, removing lacquer from a surface portion of said wafer, particularly by removing or ashing a lacquer layer, and cleaning metallic contacts on said wafer.

23. The treatment device of one of claims 1 to 4, wherein said depressions are provided with a (solid) bottom (31a), said bottom being suitable for supporting at least portions of said support pieces (20;25).

24. The support piece of claim 20, wherein a height (h1,h2) thereof is smaller than a lateral extension thereof, particularly a diameter (c,b) thereof.

25. The support piece of claim 20, wherein said support piece (20,25) comprises a bottom surface (22a) which is dimensioned relatively to a height (h2) of said piece for providing support on-its own against tilting or falling when said wafer rests upon said piece.

26. The support piece of claim 24, wherein said height (h1) compared to said lateral extension is a height of said body portion (22).

27. The support piece of claim 24, wherein said support piece has a total height (h2) which is smaller than the lateral extension (c,d).
